(19) United States
(12) Patent Application Publication
(10) Pub. No.: US 2015/0037542 A1
(43) Pub. Date: Feb. 5, 2015

(54) Composite Material That Includes Microcellular Plastic, and Related Systems and Methods

(71) Applicant: MicroGreen Polymers Inc., Arlington, WA (US)

(72) Inventors: Krishna Nadella, Redmond, WA (US); Michael Waggoner, Seattle, WA (US)

(21) Appl. No.: 14/385,461

(22) PCT Filed: Mar. 29, 2013
(86) PCT No.: PCT/US13/34668

§ 371 Date: Sep. 15, 2014

Related U.S. Application Data
(60) Provisional application No. 61/617,278, filed on Mar. 29, 2012.

(51) Int. Cl. B32B 3/28; B32B 27/08; B32B 37/00; B32B 5/18

(52) U.S. Cl. CPC B32B 3/28; B32B 5/18; B32B 27/08; B32B 37/0076; B32B 2305/02; B32B 2307/304; B32B 2250/03; B32B 2398/20
USPC 428/182; 428/98; 156/83

(57) ABSTRACT

A composite material includes a core and a shell that covers the core. The core has a volume that includes a first material and a void wherein the first material occupies less than 50% of the core's volume and has a three-dimensional shape that includes a plurality of components each having the same shape and arranged to form a series of repeating components within the volume. The shell includes a second material joined to the first material. Each of the first and second materials includes a thickness having a middle region and a outer region, and at least one of the first and second materials, includes a microstructure.

### CROSS REFERENCE TO RELATED APPLICATION AND CLAIM OF PRIORITY

This application claims priority from commonly owned U.S. Provisional Patent Applications 61/617,278 filed 29 Mar. 2012, and titled “COMPOSITE SANDWICH CORES USING MICROCELLULAR PLASTICS”, presently pending and which is incorporated by reference.

### BACKGROUND

Many composite material panels include a discrete pair of solid skin layers, each bonded to a thick core material such that the solid layers sandwich the core. The solid skin layers are normally made of a strong, stiff, high-density material to resist compression, and the core is normally made of a lighter, weaker material that stabilizes the solid skin layers against buckling and shear loads. The core and the solid skin layers include a variety of materials such as plastic, wood, glass, ceramic, metal, textile or a blend thereof. Depending on their material and construction, composite material panels impart superior mechanical and thermal insulation properties that are highly desirable in a number of applications such as in building construction, transportation vehicles, and aerospace parts.

Cores of composite panels that are made of plastic often include a low-density, foamed plastic material that occupies much if not all of the core's volume. Panels that include such cores are often made by: (1) injecting between two solid skin layers a liquid plastic, such as polyisocyanurate, polystyrene, polyvinylchloride, or foam glass, mixed with a foaming agent and then allowing the liquid mix to expand (foam) and cure while attaching itself to the underside of the solid skin layers; (2) positioning a block of previously-foamed plastic between two solid skin layers and bonding the solid skin layers to the block of previously-foamed plastic with an adhesive; and (3) applying a resin onto the surface of a previously-foamed plastic and allowing the resin to cure to form the solid skin layers.

Unfortunately, although such foamed cores provide good insulating qualities, such foamed cores do not provide good structural qualities. These foamed cores have relatively low shear strength and can buckle and crack under normal pressure. One can structurally strengthen such foamed cores by including a high-density facing layer, increasing the density of the foamed core, increasing the thickness of the foamed core, and/or including a mechanical reinforcement, but each of these solutions tends to increase the weight of and the cost of producing the composite panel.

Another solution is to design a core to have a material that has a corrugated structure and that does not occupy much of the core's volume. For example, a honeycomb structure provides good flexural strength, and good load resistance. Such honeycomb structures also provide a high strength-to-weight ratio, which allows one to reduce the total weight of a panel without compromising the panel's mechanical performance.

Because of the geometry of a corrugated-material core, such cores often include material that is easily formed into a corrugated shape. For example, such cores may often include a metal material because most metals are malleable and can thus be easily shaped into a desired corrugated structure. Similarly, such cores may also include a plastic material because plastics can be warmed to make them easily malleable or easily cast into a desired corrugated shape. Unfortunately though, because of the geometry of a corrugated-material core, the material of such cores is also typically solid, and thus, heavy for the amount of volume in the core that the material occupies. In construction, transportation and especially aerospace applications excessive weight is not good because it causes one to consume more energy to move. Therefore, there is a need for a composite material panel that provides a high strength-to-weight ratio, that can be shaped into optimal geometric configurations, and that can be produced economically.

### SUMMARY

In an aspect of the invention, a composite material includes a core and a shell that covers the core. The core has a volume that includes a first material and a void wherein the first material occupies less than 50% of the core's volume and has a three-dimensional shape that includes a plurality of components each having the same shape and arranged to form a series of repeating components within the volume. The shell includes a second material joined to the first material. Each of the first and second materials includes a thickness having a middle region and an outer region, and at least one of the first and second materials, includes a microstructure. The microstructure includes a plurality of closed cells disposed in the middle region, each cell containing a void and each cell having a maximum dimension extending across the void within the cell that ranges between 1 micrometer and 200 micrometers long, and a skin that is substantially solid and disposed in the outer region.

With the first material's three-dimensional shape in the composite material's core and at least one of the first and second materials having the microstructure, the composite material may provide more strength and stiffness than a composite material whose core has much of its volume occupied by a foamed plastic material. And, with the first material's three-dimensional shape in the composite material's core and at least one of the first and second materials having the microstructure, the composite material may be lighter than a composite material whose core and shell includes solid material but still may provide a strength and stiffness similar to the strength and stiffness of the composite material whose core and shell includes solid material. In addition, because at least one of the first and second materials has a closed-cell microstructure, the composite material is resistant to moisture, termites, and other wood-eating pests, does not corrode, and insulates better than the composite material whose core and shell includes solid material.

In another aspect, the microstructure of at least one of the first and second material includes a substantially solid layer disposed in the middle region. This solid layer is typically produced by fusion bonding two sheets of the first material together or two sheets of the second material together to increase the thickness of the first material or the second material easily and cost-effectively. With the greater thickness in the first material, the second material or both, the core, the shell or both may provide even more strength and stiffness without significantly increasing the weight of the composite panel.

### BRIEF DESCRIPTION OF THE FIGURES

FIG. 1 is a perspective view of a panel that includes a composite material, according to an embodiment of the invention,

FIG. 2 is a photograph of a cross-section of a portion of a thermoplastic material having a microstructure that is included in the composite material of the panel in FIG. 1, according to an embodiment of the invention.

FIG. 3 is schematic view of a process for generating the thermoplastic material having the microstructure shown in FIG. 2, according to an embodiment of the invention.

FIG. 4 is a schematic view of a process for generating the panel shown in FIG. 1, according to an embodiment of the invention.

FIG. 5A is a perspective view of a panel that includes a composite material, according to another embodiment of the invention.

FIG. 5B is a perspective view of a panel that includes a composite material, according to yet another embodiment of the invention.

FIG. 5C is a perspective, partial view of a panel that includes a composite material, according to still another embodiment of the invention.

FIG. 6A is a view of a composite material's core component, according to another embodiment of the invention,

FIG. 6B is a view of a composite material's core component, according to yet another embodiment of the invention.

FIG. 6C is a view of a composite material's core component, according to still another embodiment of the invention.

FIG. 7 is a photograph of a cross-section of a portion of a thermoplastic material having a dosed-cell microstructure that may be included in a composite material, according to an embodiment of the invention.

FIG. 8 is a photograph of a cross-section of a portion of a thermoplastic material having a closed-cell microstructure that may be included in a composite material, according to another embodiment of the invention.

FIG. 9 is a photograph of a cross-section of a portion of a thermoplastic material having a dosed-cell microstructure with a schematic view of a crystallinity profile of the cross-section added, according to an embodiment of the invention.

### DETAILED DESCRIPTION

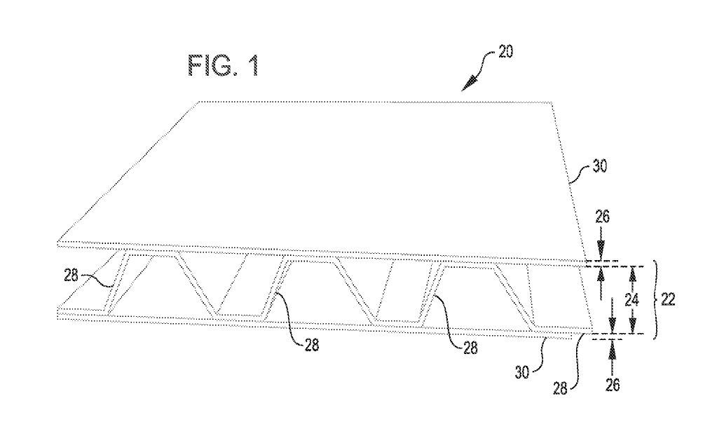

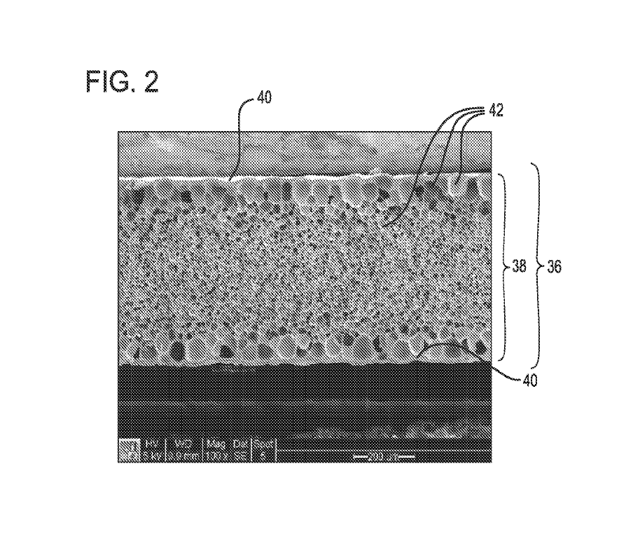

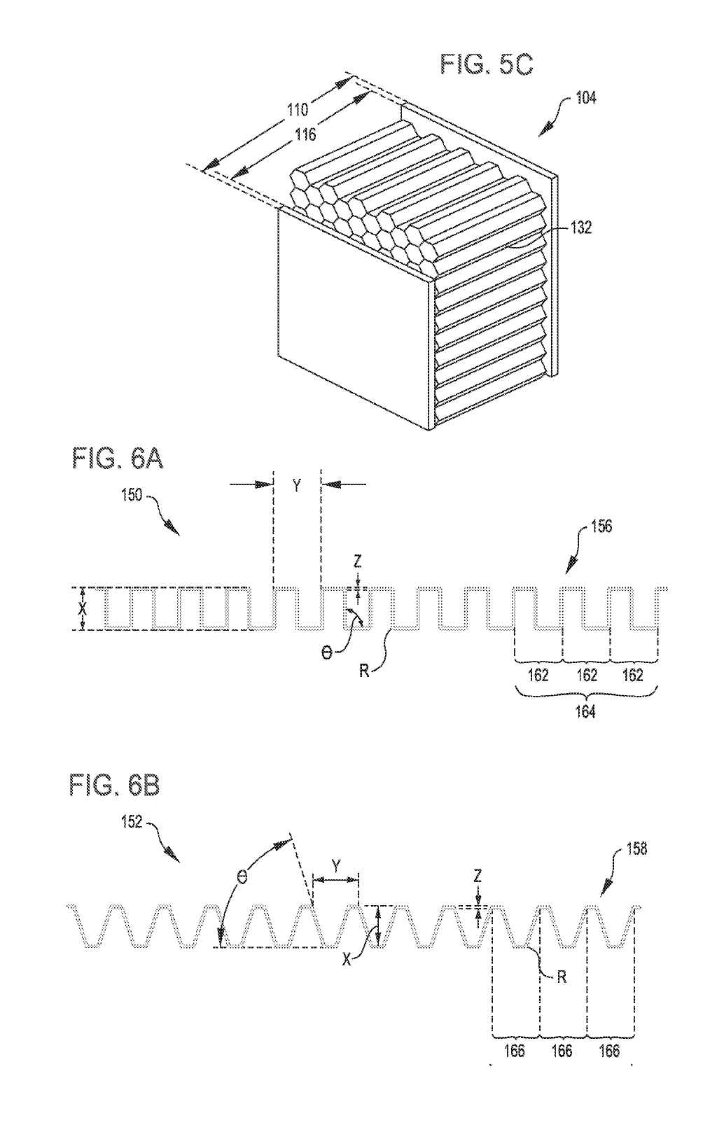

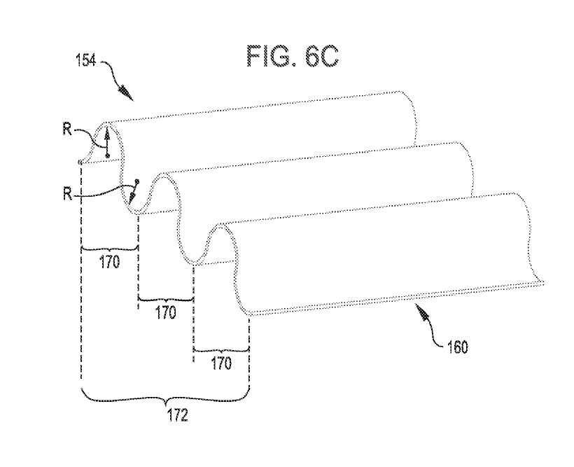

FIG. 1 is a perspective view of a panel 20 that includes a composite material 22 according to an embodiment of the invention. The panel 20 (here substantially flat and rectangular) may have any shape desired. For example, the panel 20 may curve in three dimensions like a nose cone for a jet airliner. In addition, the panel 20 may be any size desired. The composite material 22 includes a core 24 and a shell 26 that covers the core 24. Here, the shell 26 sandwiches the core 24 but in other embodiments the shell 26 may cover only one side of the core 24, or may cover only a portion of a side of the core 24. The core 24 has a volume determined by the distance between the shell 26 multiplied by the area of a cross-section that is between the shell 26 and that extends parallel to the shell. Within this volume lies a first material 28 that occupies 50% or less of the core's volume and that has a three-dimensional shape (discussed in greater detail in conjunction with FIGS. 5A-6C) that includes a plurality of components each having the same shape and arranged to form a series of repeating components within the volume. The shell 26 includes a second material 30 that is joined to the core's first material. Each of the first and second materials includes a thickness that has a middle region and an outer region, and at least one of the first and second materials includes a microstructure (discussed in greater detail in conjunction with FIGS. 2 and 7-9) that includes a plurality of closed-cells disposed in the middle region and a skin that is substantially solid and disposed in the outer region.

With the first material's three-dimensional shape in the composite material's core 24 and at least one of the first and second materials 28 and 30, respectively, having the microstructure, the composite material 22 may provide more strength and stiffness than a composite material whose core has much of its volume occupied by a foamed plastic material. And, with the first material's three-dimensional shape in the composite material's core and at least one of the first and second materials having the microstructure, the composite material 22 may be lighter than a composite material whose core and shell includes material that is solid, but still provide a strength and stiffness similar to the strength and stiffness of the composite material whose core and shell includes solid material. In addition, because at least one of the first and second materials has a closed-cell microstructure, the composite material is resistant to moisture, termites, and other wood-eating pests, does not corrode, and insulates better than the composite material whose core and shell includes solid material.

Still referring to FIG. 1, the first and/or second materials 28 and 30, respectively, may include any desired plastic material. For example, in this and other embodiments the first and the second materials 28 and 30, respectively, include acrylonitrile butadiene styrene polycarbonate (ABS PC). In other embodiments, the first and the second materials 28 and 30, respectively, may include one or more of the following plastics: polystyrene, polycarbonate, polyethylene terephthalate (PET), glycol modified PET, polyethylene, polypropylene, NORYL (a blend of polyphenylene oxide and polystyrene), polyvinyl chloride, and crystallizable PET (CPET). In still other embodiments, the first material 28 may include one or more of the previously mentioned plastics, and the second material 30 may include a different one or more of the previously mentioned plastics.

The second material 30 of the shell 26 may be joined to the first material 28 of the core 24 using any desired means. For example, in this and other embodiments the second material 30 and the first material 28 are fused together by melting a portion of the outer surface of both of the first and second materials 28 and 30, respectively, and then exerting pressure on the portions to cause the melted material of each to coalesce. An example of such a fusion process is described in POT patent application PCT/US11/33075, filed 19 Apr. 2011, titled “A METHOD FOR JOINING THERMOPLASTIC POLYMER MATERIAL”, hereby incorporated by reference. In other embodiments, an adhesive (not shown) between the first and second materials 28 and 30, respectively, fastens the two materials together to form the panel 20. In still other embodiments, an agent disposed between the two materials 28 and 30 may join the two materials 28 and 30 to each other when heated to an activating temperature.

Still referring to FIG. 1, the composite material 22 may be configured as desired. For example, in this and other embodiments, both the first material 28 and the second material 30 have a microstructure that includes a plurality of closed-cells disposed in the middle region and a skin that is substantially solid and disposed in the outer region. In other embodiments, the first material 28 includes such a microstructure, while the second material 30 does not. In still other embodiments, the second 30 includes such a microstructure, while the first material 28 does not. In addition, the composite material may be configured to be six inches thick with the portion of the shell 26 that covers the top of the core 24 being 0.250 inches thick, and the portion of the shell 26 that covers the bottom of the core 24 also being 0.250 inches thick. In other embodiments, the thickness of the panel 20 may be more or less than six inches and the thickness of each portion of the shell 26 may be more or less than 0.250 inches thick. In still other embodiments, the portion of the shell 26 that covers the top of the core 24 may have a thickness that is different than the thickness of the portion of the shell 26 that covers the bottom of the core 24.

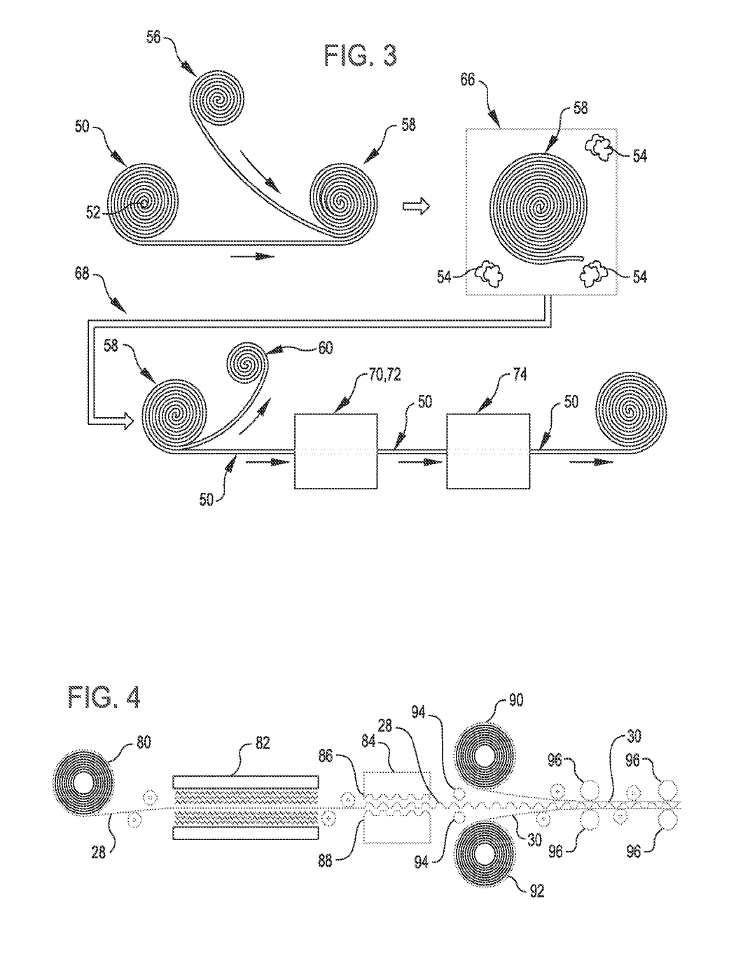

FIG. 2 is a photograph of a cross-section of a portion of a thermoplastic material 36 having a microstructure 38 that is included in the composite material 22 in FIG. 1, according to an embodiment of the invention. The microstructure 38 includes a skin 40 (here two), and many (typically 10⁸ or more per cubic centimeter) microcellular bubbles 42 (only three labeled for clarity) whose cell sizes typically range from 0.1 to 200 micrometers and are closed. These many bubbles or closed-cells 42 form an interior that is sandwiched between the skins 40. Each skin 40 is a smooth, outer-layer whose microstructure does not include closed-cells 42 or at most far fewer closed-cells 42 than the interior of the material 36, and is thus substantially solid. In this and other embodiments, each skin 40 is integral to the closed-cells 42. More specifically, each skin 40 and the plurality of dosed-cells 42 are formed during a single process, such as that shown and discussed in conjunction with FIG. 3, and from the same initial sheet of solid thermoplastic material. In other embodiments, the skin 40 may not be integral to the dosed-cells 42, but formed after the closed-cells 42 have been formed.

The size of each dosed cell 42 may be any desired size, and the distribution of the dosed cells 42 throughout the thickness of the material 36 may be any desired distribution. For example, in this and other embodiments the size of each dosed cell ranges between 1 and 60 micrometers long at its maximum dimension that extends across the void within the cell, and the closed cells may be uniformly dispersed throughout the interior of the material 36. Because the geometry of each closed-cell is rarely, if at all, a perfect sphere, the size of each closed cell is arbitrarily identified as the length of the longest chord that extends through the void within the closed cell. For example, the size of an oblong cell would be the length of the longest chord that extends in the same direction as the cell's elongation, and the size of a sphere would be the length of the sphere's diameter.

With the many closed-cells 42 in the interior of the material 36, the material 36 is substantially thicker than and has a cross-sectional area substantially greater than, the same material before the closed-cells 42 are generated, but maintains the same amount of thermoplastic material. Thus, the material 36 has a relative density that ranges between 10% and 40%. The relative density is the density of the material 36 whose volume includes the closed-cells 42, divided by, the density of the same amount of material whose volume does not include any of the closed-cells 42—i.e. is solid. With the relative density of the material 36 less than the density of the same material in solid form, the material 36 may be lighter than a composite material whose core and shell includes solid material but still may provide a strength and stiffness similar to the strength and stiffness of the composite material whose core and shell includes solid material.

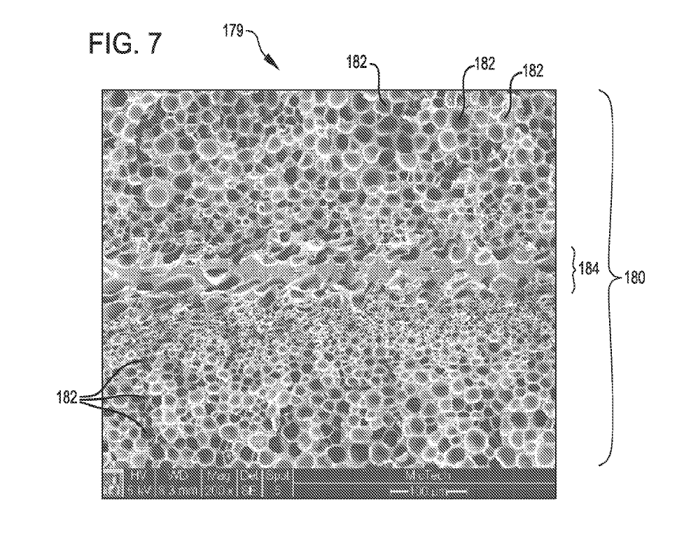

Other embodiments are possible. For example, the microstructure 38 of the thermoplastic material 36 may be similar to one or more of the microstructures discussed in greater detail in conjunction with FIGS. 7-9.

FIG. 3 is a schematic view of a process for generating the thermoplastic material 36 having the microstructure 38 shown in FIG. 2, according to an embodiment of the invention. This process may also be used to help generate the microstructures shown in FIGS. 7-9.

In this and other embodiments, the process includes dissolving into the material 50 (here shown as a film rolled around a drum 52, but may be a block or thin sheet) a gas 54 that does not react with the material 50. The process also includes heating the material 50 with the dissolved gas at a temperature that is, is close to, or above the glass-transition temperature of the material and dissolved gas combination. The glass-transition temperature is the temperature at which the material 50 is easily malleable but has not yet melted. With the temperature at, near, or above the glass-transition temperature, bubbles of the gas 54 can nucleate and grow in regions of the material 50 that are thermodynamically unstable—i.e. supersaturated. When the bubbles have grown to a desired size, the temperature of the material 50 is reduced below the glass-transition temperature to stop the bubbles' growth, and thus provide the material 50 with a microstructure having closed-cells whose size may range between and 500 micrometers long.

In the process, the first step 66 is to dissolve into the material 50 any desired gas 54 that does not react with the material 50. For example, in this and certain other embodiments of the process, the gas 54 may be carbon dioxide (CO₂) because CO₂ is abundant, inexpensive, and does not react with PET. In other embodiments of the process, the gas may be nitrogen and/or helium. Dissolving the gas 54 into the material 50 may be accomplished by exposing the material for a period of time to an atmosphere of the gas 54 having a temperature and a pressure. The temperature, pressure, and period of time may be any desired temperature, pressure, and period of time to dissolve the desired amount of gas 54 into the material 50. The amount of gas 54 dissolved into the material 50 is directly proportional to the pressure of the gas 54 and the period of time that the material 50 is exposed to the gas 54 at a specific temperature and specific pressure, but is inversely proportional to the temperature of the gas 54. For example, in this and certain other embodiments, the temperature may be 72° Fahrenheit, the pressure may be 725 pounds per square inch (psi), and the duration of the period may be 10 hours. This typically saturates the material 50 with the gas 54. In other embodiments, the pressure may range between 500 psi and 1000 psi, and the duration of the period may range between 4 hours and 48 hours.

Because the layers of the rolled material film 50 that lie between adjacent layers or between a layer and the drum 52 are substantially unexposed to the atmosphere when the roll is placed in the atmosphere, a material 56 is interleaved between each layer of the rolled material film that exposes each layer to the atmosphere. In this and certain other embodiments, the material 56 includes a sheet of cellulose, and is disposed between each layer of the material film 50 by merging the sheet with the film and then rolling the combination into a single roll 58. The material 56 exposes each layer of the material film 50 by allowing the gas 54 to easily pass through it. After the gas 54 has saturated the material film 50, the material 56 may be removed from the roll 58 and saved as a roll 60 for re-use.

The next step 68 in the process includes exposing the material film 50 with the dissolved gas 54 to an atmosphere having less pressure than the one in the first step to cause the combination of the material film 50 and the gas 54 dissolved in the material film 50 to become thermodynamically unstable—i.e. the whole material or regions of the material to become supersaturated with the dissolved gas 54. For example, in this and certain other embodiments, the reduction in pressure may be accomplished by simply exposing the material film 50 to atmospheric pressure, which is about 14.7 psi, in the ambient environment.

When the combination of the material film 50 and the dissolved gas 54 becomes thermodynamically unstable, the dissolved gas tries to migrate out of the film 50 and into the ambient environment surrounding the film 50. Because the dissolved gas in the interior regions of the material film 50 must migrate through the regions of the material film 50 that are closer to the film's surface to escape from the material film 50, the dissolved gas in the interior regions begins to migrate after the dissolved gas in the surface regions begins to migrate, and takes more time to reach the ambient environment surrounding the material film 50 than the dissolved gas 54 in the film's regions that is closer to the film's surface. Thus, before heating the material film 50 to a temperature that is, is dose to or above its glass-transition temperature, one can modify the concentration of dissolved gas 54 in regions of the material film 50 by exposing for a period of time the material film 50 to an atmosphere having less pressure than the one in the first step. Because the concentration of dissolved gas 54 depends on the amount of gas that escapes into the ambient environment surrounding the material film 50, the concentration of dissolved gas 54 is inversely proportional to the period of time that the film 50 is exposed to the low-pressure atmosphere before being heated to, close to, or above its glass-transition temperature.

In this manner, a skin, such as the skin 40 (FIG. 2), may be formed in the material film 50 when the film 50 is heated to a temperature that is, is close to or above its glass-transition temperature. For example, in this and certain other embodiments, the roll 58 of material film and interleaved material 56 can remain in a thermodynamically unstable state for a period of time before removing the material 56 from the roll 58 and heating the film. This allows some of the gas dissolved in the region of the film adjacent the film's surface to escape. With the gas absent from this region of the film, this region becomes more thermodynamically stable than the regions that are further away from the film's surface. With a sufficient amount of thermodynamic stability in the region, bubbles won't nucleate in the region when the film is heated to, close to, or above its glass-transition temperature. Consequently, closed-cells 42 (FIG. 2) can be omitted from this region of the film, leaving a solid portion of the microstructure that is integral to the closed cell portion of the microstructure, such as the skin 40 (FIG. 2). Because the thickness of the skin 40 or solid portion depends on the absence of dissolved gas 54 in the region of the film 50, the thickness of the skin 40 or solid portion is directly proportional to the period of time that the film 50 spends in a thermodynamically unstable state before being heated to, close to, or above its glass-transition temperature. In this and certain other embodiments, the thickness of the integral skin ranges 5-100 micrometers.

The next steps 70 and 72 in the process are to nucleate and then grow bubbles in the material 50 to achieve a desired relative density for the material film 50. The relative density is the density of the material film 50 with the closed cells divided by the density of the material 50 without the closed cells. Bubble nucleation and growth begin about when the temperature of the material film 50 is or is close to the glass-transition temperature of the material film 50 with the dissolved gas 54. The duration and temperature at which bubbles are nucleated and grown in the material 50 may be any desired duration and temperature that provides the desired relative density. For example, in this and certain other embodiments, the temperature that the PET material 50 is heated to is approximately 200°-280° Fahrenheit, which is about 40°-120° warmer than the glass-transition temperature of the material without any dissolved gas 54. The PET film 50 is held at approximately 200°-280° Fahrenheit for approximately 30 seconds. This provides a relative density of the closed-cell film of about 18.5%. If the PET film 50 is held at 200°-280° Fahrenheit for a period longer than 30 seconds, such as 120 seconds, then the bubbles grow larger, and thus the size of resulting closed-cells 42 (FIG. 2) are larger. This may provide a relative density of the closed-cell film of about 10%-20%. If the PET film 50 is held at 200°-280° Fahrenheit for a period shorter than 30 seconds, such as 10 seconds, then the bubbles remain small, and thus the size of resulting closed-cells 42 (FIG. 2) are smaller. This may provide a relative density of the closed-cell film of about 40%.

To heat the material film 50 that includes the dissolved gas 54, one may use any desired heating apparatus. For example, in this and certain other embodiments, the PET film may be heated by a roll fed flotation/impingement oven, disclosed in the currently pending U.S. patent application Ser. No. 12/423,790, titled ROLL FED FLOTATION/IMPINGEMENT AIR OVENS AND RELATED THERMOFORMING SYSTEMS FOR CORRUGATION-FREE HEATING AND EXPANDING OF GAS IMPREGNATED THERMOPLASTIC WEBS, filed 14 Apr. 2009, and incorporated herein by this reference. This oven suspends and heats a material film that moves through the oven, without restricting the expansion of the film.

The next step 74 in the process includes reducing the temperature of the heated material 50, and thus the malleability of the material 50 that occurs at, near, or above the glass-transition temperature, to stop the growth of the bubbles. The temperature of the heated material may be reduced using any desired technique. For example, in this and certain other embodiments, the material film 50 may be left to cool at ambient room temperature—i.e. simply removed from the heating apparatus. In other embodiments the heated material film 50 may be quenched by drenching it with cold water, cold air, or any other desired medium.

Other embodiments of the process are possible. For example, the material film 50 can be heated to a temperature that is or is close to its glass-transition temperature when the material film 50 is initially exposed to an atmosphere that causes the gas dissolved in the material film 50 to become thermodynamically unstable. This allows one to make a film that includes a skin having a minimal thickness.

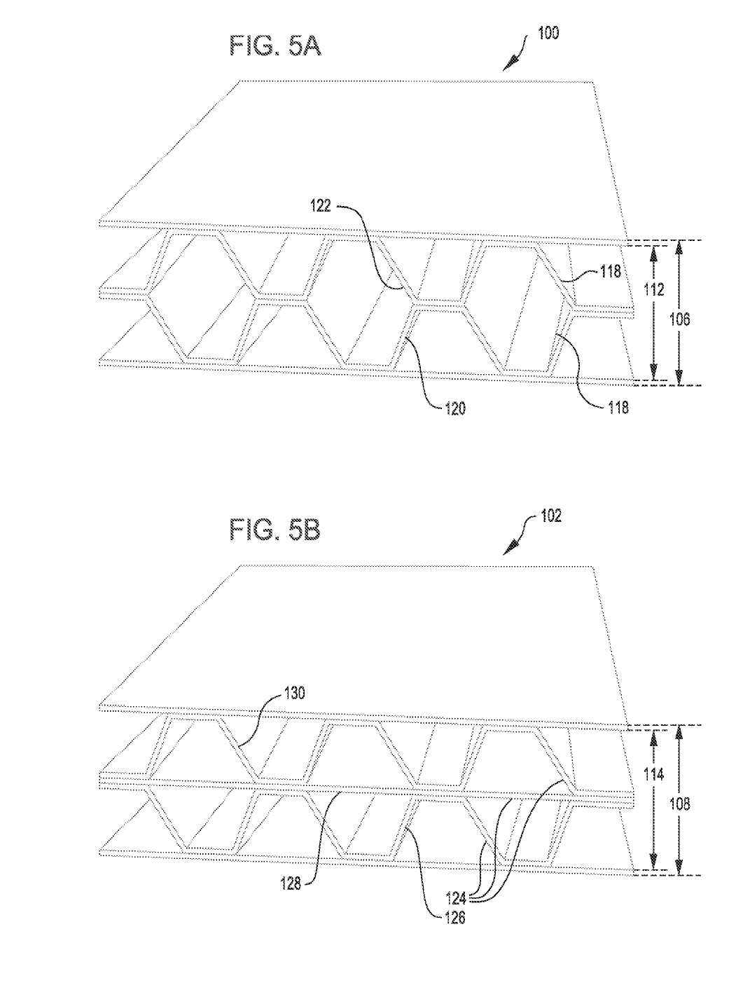

FIG. 4 is a schematic view of a process for generating the composite material 22 shown in FIG. 1, according to an embodiment of the invention. The process includes generating the microstructure 38 (FIGS. 2 and 7-9) in the first material 28 (FIG. 1), the second material 30 (FIG. 1), or both (here just the first material 28), forming a three-dimensional shape (discussed in greater detail in conjunction with FIGS. 6A-6C) in the first material 28, then joining the first material 28 to the second material 30.

In this and other embodiments, the process includes heating the first material 28 from the roll 80 just before thermoforming the first material 28 into the desired three-dimensional shape. The first material 28 in the roll 80 includes a substantial amount of gas that the material 28 has absorbed so that when the material 28 is heated the microstructure 38 is formed in the material. In other embodiments, the process may include simultaneously heating the first material 28 to form the microstructure 38 and thermoforming the first material 28 into the desired three-dimensional shape. In still other embodiments, the process may include heating the first material 28 to form the microstructure 38 a substantial amount time before thermoforming the first material 28. In such embodiments, the first material 28 in the roll 80 may already include the microstructure 38.

Still referring to FIG. 4, in this and other embodiments, the first material 28 is unwound from the roll 80 and fed through an air oven 82 that heats the first material to or near the glass-transition temperature of the gas-impregnated material 28 to generate the microstructure 38. The expanded material 28 is then fed between a corrugated the press 84 that includes an upper platen 86 and lower platen 88, to thermoform the material into the desired three-dimensional shape. The platens 86 and 88 are offset from each other so that the convex portion of one platen fits, respectively, into the concave portion of the other platen when they dose. As the material 28 advances through the press, the upper and lower platens 86 and 88 dose to exert pressure on the material to form it into the three-dimensional shape. Because the material 28 does not move through the press 82 as the press exerts pressure on the material 28, the material 28 does not continuously move as it is processed. To reduce processing time, other embodiments may include a press 84 that includes two or more wheels (not shown) whose circumferences are configured similar to the platens 86 and 88 and arranged such that as they rotate, the two circumferences press against the material 28 as the material moves between the wheels and forms the desired three-dimensional shape.

Once thermoformed, the first material 28 is then inserted between two sheets of the second material 30, each unwound from a respective one of the roils 90 and 92. Each sheets' inner surface is then fusion bonded with the first material 28. To help fuse the two sheets of the second material 30 to the first material 28, heated rollers 94 heat the first material 28 and each sheet of the second material 30 to melt the regions of each to be fused together. In addition, nip rollers 96 exert pressure on each sheet of the second material to help fuse the two sheets of the second material 30 to the first material 28.

Other embodiments of the process are possible. For example, two or more sheets of a first material 28 may each be thermoformed into a desired three-dimensional shape and then joined together before the second material 30 is joined to them (discussed in greater detail in conjunction with FIGS. 5A-5C).

FIGS. 5A-5C are perspective views of a panel that includes a composite material, according to embodiments of the invention. Each of the panels 100 (FIG. 5A), 102 (FIG. 5B), and 104 (FIG. 5C), includes a composite material 106 (FIG. 5A), 108 (FIG. 5B), and 110 (FIG. 5C), respectively, that is similar to the composite material 22 (FIG. 1) except that the three-dimensional shape of each composite material's core 112 (FIG. 5A), 114 (FIG. 5B), and 116 (FIG. 5C), respectively, is different than each of the other composite material core's three-dimensional shape.

Referring to FIG. 5A, in this and other embodiments the first material 118 includes two sheets 120 and 122. Both sheets 120 and 122 include the microstructure 38 (FIG. 2) and are fused together to form the first material 118 having the three-dimensional shape shown. In other embodiments, one of the sheets 120 or 122 may include the microstructure 38 and the other sheet 122 or 120 may not. In addition the two sheets may be joined by any other desired means, such as an adhesive or a temperature activated agent.

Referring to FIG. 5B, in this and other embodiments the first material 124 includes three sheets 126, 128 and 130. Sheets 126 and 130 are similar to the sheets 120 and 122 (FIG. 5A), but sheet 128 is a flat rectangular sheet. Each of the sheets 126, 128 and 130 include the microstructure 38 (FIG. 2) and are fused together to form the first material 118 having the three-dimensional shape shown. In other embodiments, one or two of the sheets 126, 128 and 130 may include the microstructure 38, while the other sheet or sheets don't. In addition the three sheets may be joined by any other desired means, such as an adhesive or a temperature activated agent.

Referring to FIG. 5C, in this and other embodiments the first material 132 includes a plurality of sheets, each having the microstructure 38 and each fused to one or two adjacent sheets and then oriented to form a three-dimensional shape similar to a honeycomb. With such a three-dimensional shape, the first material 132 may occupy 25% of the volume of the core 116. In other embodiments, one or more of the sheets may include the microstructure 38, while other sheets don't. In addition the sheets may be joined by any other desired means, such as an adhesive or a temperature activated agent.

FIGS. 6A-6C are views of a composite material's first material, according to embodiments of the invention. Each of first materials 150 (FIG. 6A), 152 (FIG. 6B), and 154 (FIG. 6C) is similar to the first material 28 (FIG. 1) except that the three-dimensional shape 156 (FIG. 6A), 158 (FIG. 6B), and 160 (FIG. 6C) of each respective first material 150, 152, and 154 is different than each of the other first material's three-dimensional shape.

Referring to FIG. 6A, in this and other embodiments the three-dimensional shape 156 includes a plurality of components 162 (only three labeled for clarity) arranged to form a series 164 (partially labeled for clarity) of repeating components 162. More specifically, each component 162 of the three-dimensional shape 156 is configured such that the dimension labeled “X” is 0.79 inches, the dimension labeled “Y” is 1.0 inch, the dimension labeled θ is 0.040 inches, the radius labeled “R” is 0.020 inches, and the angle labeled θ is 90 degrees. In other embodiments, one or more of the dimensions, radius and angle may be more or less than those specified here.

Referring to FIG. 6B, in this and other embodiments the three-dimensional shape 158 includes a plurality of components 166 (only three labeled for clarity) arranged to form a series 168 (partially labeled for clarity) of repeating components 166. More specifically, each component 166 of the three-dimensional shape 158 is configured such that the dimension labeled “X” is 0.79 inches, the dimension labeled “Y” is 1.0 inch, the dimension labeled “Z” is 0.040 inches, the radius labeled “R” is 0.020 inches, and the angle labeled θ is 71.57 degrees. In other embodiments, one or more of the dimensions, radius and angle may be more or less than those specified here.

Referring to FIG. 6C, in this and other embodiments the three-dimensional shape 160 includes a plurality of components 170 arranged to form a series 172 of repeating components 170. More specifically, the thickness of the first material 154 is 0.10 inches and the radius labeled R is 0.50 inches. In other embodiments, one or more of the dimensions and radius may be more or less than those specified here.

Other embodiments are possible. For example, the three-dimensional shape of the first material may include a combination of two or more of the three-dimensional shapes 156, 158, and 160. For another example, the three-dimensional shape of the first material may include any other desired three-dimensional shape.

FIGS. 7-9 are photographs of a cross-section of a portion of a thermoplastic material having a microstructure that may be included in a composite material, according to embodiments of the invention.

Referring to FIG. 7, the thermoplastic material 179 includes a microstructure 180 whose middle region includes closed-cells 182 (only six labeled for clarity), and a layer 184 that is substantially solid. The layer 184, in this and other embodiments, is generated by fusing a skin, such as the skin 40 (FIG. 2) of the material 36 (FIG. 2), with another skin of another material 36. This may be desirable to increase the thickness of a first material 28 (FIG. 1) and/or the second material 30 (FIG. 1) without having to process (as discussed in conjunction with FIG. 3) a thick sheet of thermoplastic material. This may also be desirable to form a first material 28 and/or a second material 30 having any desired, specific thickness. Similar to the fusion process discussed in conjunction with FIG. 1, the two skins may be fused together by the fusion process described in POT patent application PCT/US11/33075, filed 19 Apr. 2011, titled “A METHOD FOR JOINING THERMOPLASTIC POLYMER MATERIAL”.

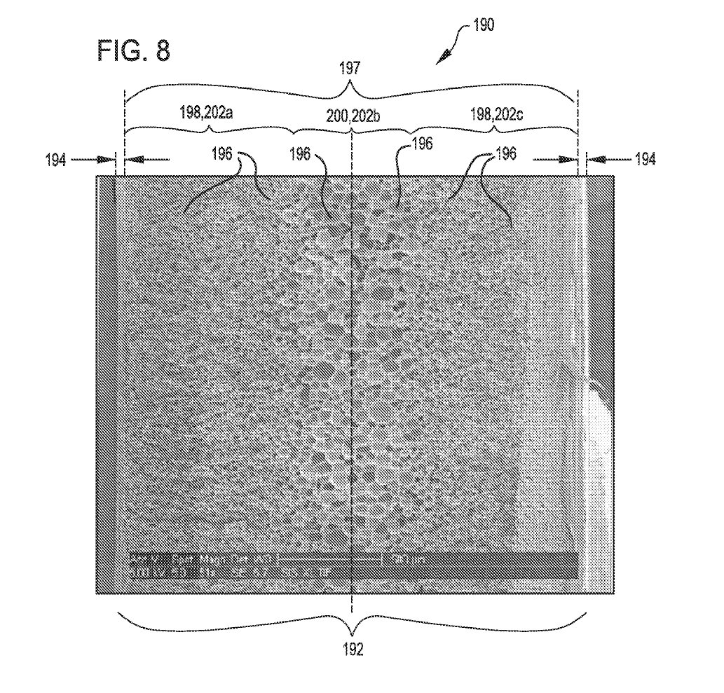

Referring to FIG. 8, in this and other embodiments, the thermoplastic material 190 includes a microstructure 192 that has a skin 194 (here two) and a plurality of closed-cells 196 (only six labeled for clarity) disposed in a middle region 197. The plurality of closed-cells 196 include groups of closed-cells that are substantially the same size within each group but that are larger or smaller than the closed-cells 196 in an adjacent group. More specifically, a first group 198 of closed-cells 196 is located adjacent each skin 194, and second group 200 of closed-cells 196 is located between the first group 196. The two groups 198 and 200 are arranged such that they form three discrete layers 202a-202c within the middle region 197. An example of such a microstructure 192 and a process for generating the microstructure 192 is disclosed in the currently pending U.S. patent application Ser. No. 12/566,520, titled, “MULTI-LAYERED FOAMED POLYMERIC OBJECTS HAVING SEGMENTED AND VARYING PHYSICAL PROPERTIES, AND RELATED METHODS”, filed 24 Sep. 2009, and hereby incorporated by reference.

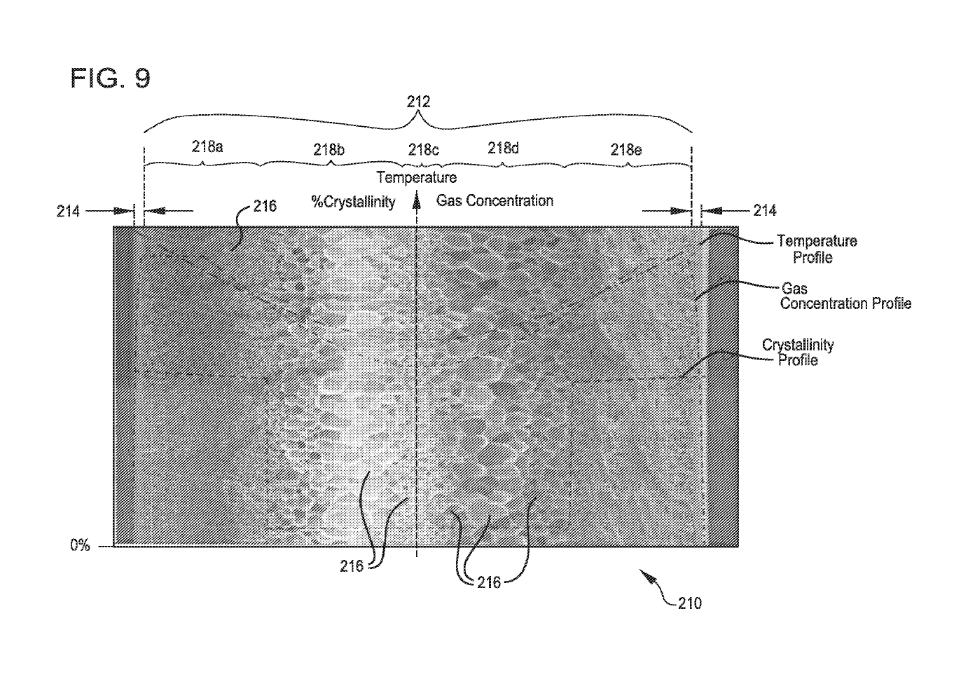

Referring to FIG. 9, in this and other embodiments, the thermoplastic material 210 includes a microstructure 212 that has a skin 214 (here two) and a plurality of closed-cells 216 (only six labeled for clarity) disposed in a middle region. Similar to the microstructure 192 (FIG. 8), the microstructure 212 includes groups of similarly sized dosed-cells 216, but unlike the microstructure 192 that includes two groups, the microstructure 212 includes three groups that are arranged such that they form five discrete layers 218a-218e. In addition, the microstructure 212 includes a crystallinity gradient across the thickness of the material 210 in which the crystallinity of the skin is greater than the crystallinity of the discrete layer 218c. An example of such a microstructure 212 and a process for generating the microstructure 212 is also disclosed in the currently pending U.S. patent application Ser. No. 12/566,520, titled, “MULTI-LAYERED FOAMED POLYMERIC OBJECTS HAVING SEGMENTED AND VARYING PHYSICAL PROPERTIES, AND RELATED METHODS”, filed 24 Sep. 2009, and hereby incorporated by reference.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A composite material comprising:
a core having a volume that includes a first material and a void wherein the first material occupies less than 50% of the volume and has a three-dimensional shape that includes a plurality of components each having the same shape and arranged to form a series of repeating components within the volume;
a shell covering the core and having a second material joined to the first material; and
wherein each of the first and second materials includes a thickness having a middle region and an outer region, and wherein at least one of the first and second materials, includes:
a microstructure that includes:
a plurality of closed cells disposed in the middle region, each cell containing a void and each cell having a maximum dimension extending across the void within the cell that ranges between 1 micrometer and 200 micrometers long; and
a skin that is substantially solid and disposed in the outer region.

2. The composite material of claim 1 wherein at least one of the first and second materials includes at least one of the following: polyethylene terephthalate (PET), polystyrene, polycarbonate, acrylonitrile-butadiene-styrene, glycol modified PET, polyethylene, polypropylene, NORYL (a blend of polyphenylene oxide and polystyrene), polyvinyl chloride, and crystallizable PET (CPET).

3. The composite material of claim 1 wherein the first material includes the microstructure that includes:
a plurality of dosed cells disposed in the middle region, each cell containing a void and each cell having a maximum dimension extending across the void within the cell that ranges between 1 micrometer and 200 micrometers long, and
a skin that is substantially solid and disposed in the outer region.

4. The composite material of claim 1 wherein the first material occupies 25% of the core's volume.

5. The composite material of claim 1 wherein the three-dimensional shape includes a corrugated sheet.

6. The composite material of claim 1 wherein the component shape includes a “ [symbol] ”, and the plurality of components are arranged as “ [symbol] ”.

7. The composite material of claim 1 wherein the component shape includes a “ [symbol] ”, and the plurality of components are arranged as “ [symbol] ”.

8. The composite material of claim 1 wherein the three-dimensional shape includes a first set of a plurality of components each having the same shape and arranged to form a series of repeating components within the volume, and a second set of a plurality of components each having the same shape and arranged to form a series of repeating components within the volume, wherein the first set is disposed above the second set within the volume.

9. The composite material of claim 1 wherein the second material includes the microstructure that includes:
a plurality of dosed cells disposed in the middle region, each cell containing a void and each cell having a maximum dimension extending across the void within the cell that ranges between 1 micrometer and 200 micrometers long, and
a skin that is substantially solid and disposed in the outer region.

10. The composite material of claim 1 wherein the shell sandwiches the core.

11. The composite material of claim 1 wherein the dosed cells disposed in the middle region are uniformly distributed throughout the middle region.

12. The composite material of claim 1 wherein the maximum dimension extending across the void within each dosed cell ranges between 1 micrometers and 60 micrometers.

13. The composite material of claim 1 wherein the material having the microstructure has a relative density that ranges between 10% and 40%, wherein the relative density is the density of the material having the plurality of dosed cells, divided by, the density of the same material without the dosed cells.

14. The composite material of claim 1 wherein the microstructure includes a crystallinity gradient such that the crystallinity of the skin is greater than the crystallinity of the middle region.

15. The composite material of claim 1 wherein the microstructure of the middle region includes a plurality of discrete layers each having a plurality of dosed cells whose maximum dimension is different than the maximum dimension of the dosed cells in the adjacent layer.

16. A composite material comprising:
a core having a volume that includes a first material and a void wherein the first material occupies less than 50% of the volume and has a three-dimensional shape that includes a plurality of components each having the same shape and arranged to form a series of repeating components within the volume;
a shell covering the core and having a second material joined to the first material; and
wherein each of the first and second materials includes a thickness having a middle region and an outer region, and wherein at least one of the first and second materials, includes:
a microstructure that includes:
a plurality of closed cells disposed in the middle region, each cell containing a void and each cell having a maximum dimension extending across the void within the cell that ranges between 1 micrometer and 200 micrometers long,
a substantially solid layer disposed in the middle region, and
a skin that is substantially solid and disposed in the outer region.

17. The composite material of claim 16 wherein the first material includes the microstructure that includes:
a plurality of closed cells disposed in the middle region, each cell containing a void and each cell having a maximum dimension extending across the void within the cell that ranges between 1 micrometer and 200 micrometers long,
a substantially solid layer disposed in the middle region, and
a skin that is substantially solid and disposed in the outer region.

18. The composite material of claim 16 wherein the first material includes two or more sheets bonded together such that the first material's thickness is greater than the thickness of each of the sheets.

19. The composite material of claim 16 wherein the first material includes two or more sheets fusion bonded together such that the first material's thickness is greater than the thickness of each of the sheets.

20. A composite material panel comprising:
A composite material including:
a core having a volume that includes a first material and a void wherein the first material occupies less than 50% of the volume and has a three-dimensional shape that includes a plurality of components each having the same shape and arranged to form a series of repeating components within the volume;
a shell sandwiching the core and having a second material joined to the first material; and
wherein the first material includes:
a thickness having a middle region and an outer region, and
a microstructure that includes:
a plurality of dosed cells disposed in the middle region, each cell containing a void and each cell having a maximum dimension extending across the void within the cell that ranges between 1 micrometer and 200 micrometers long; and
a skin that is substantially solid and disposed in the outer region.

21. The composite material panel of claim 20 wherein the first and second materials are fusion bonded to join the shell with the core.

22. The composite material panel of claim 20 wherein the thickness of the first material is 0.250 inches, and the thickness of the panel is six inches.

23. The composite material panel of claim 20 wherein the shell is a flat sheet.

24. A method for forming a composite material, the method comprising:
joining a core with a shell, the core having a volume that includes a first material and a void wherein the first material occupies less than 50% of the volume and has a three-dimensional shape that includes a plurality of components each having the same shape and arranged to form a series of repeating components within the volume, and the shell having a second material, wherein:
each of the first and second materials includes a thickness having a middle region and an outer region, and
at least one of the first and second materials includes a microstructure that includes:
a plurality of dosed cells disposed in the middle region, each cell containing a void and each cell having a maximum dimension extending across the void within the cell that ranges between 1 micrometer and 200 micrometers long, and
a skin that is substantially solid and disposed in the outer region.

25. The method of claim 24 wherein joining the core with the shell includes fusion bonding.

26. The method of claim 24 further comprising forming the three-dimensional shape of the first material.

27. The method of claim 26 wherein forming the three-dimensional shape of the first material includes thermoforming the first material.

28. The method of claim 24 further comprising generating the microstructure of the polymer by:
exposing layers of a roll of a polymer film to an atmosphere of a gas pressurized to saturate the polymer film with the gas, the roll of the polymer film including a material disposed between the layers of the rolled polymer film to expose to the atmosphere the region of the polymer layers that the material lies between;
nucleating the plurality of closed cells by:
reducing the pressure of the gas atmosphere to cause the exposed layers of the polymer film to become supersaturated, and
heating the exposed layers of the polymer film to at least a glass transition temperature of the polymer material;
holding the temperature of the exposed layers for a period of time to grow the size of the cells; and
reducing the temperature of the exposed layers to stop the growth in size of the cells.

29. The method of claim 28 further comprising simultaneously forming the three-dimensional shape of the first material and nucleating the plurality of cells.

30. The method of claim 24 wherein each of the first and second materials includes a microstructure that includes:
a plurality of closed cells disposed in the middle region, each cell containing a void and each cell having a maximum dimension extending across the void within the cell that ranges between 1 micrometer and 200 micrometers long; and
a skin that is substantially solid and disposed in the outer region; and
further comprising generating the microstructure of the polymer by:
exposing layers of a roll of a polymer film to an atmosphere of a gas pressurized to saturate the polymer film with the gas, the roll of the polymer film including a material disposed between the layers of the rolled polymer film to expose to the atmosphere the region of the polymer layers that the material lies between;
nucleating the plurality of closed cells by:
reducing the pressure of the gas atmosphere to cause the exposed layers of the polymer film to become supersaturated, and
heating the exposed layers of the polymer film to at least a glass transition temperature of the polymer material;
holding the temperature of the exposed layers for a period of time to grow the size of cells; and
reducing the temperature of the exposed layers to stop the growth in size of the cells.
